(19) United States
(12) Patent Application Publication
(10) Pub. No.: US 2025/0100487 A1
(43) Pub. Date: Mar. 27, 2025

(54) MECHANISM FOR ADJUSTING THE ORIENTATION OF A HIGH VOLTAGE JUNCTION BOX/ POWER DISTRIBUTION UNIT

(71) Applicant: Daimler Truck AG, Leinfelden-Echterdingen (DE)

(72) Inventor: Nandesh Hubballimath, Bangalore (IN)

(21) Appl. No.: 18/889,841

(22) Filed: Sep. 19, 2024

(30) Foreign Application Priority Data
Sep. 21, 2023 (IN) 202341063331

(51) Int. Cl. B60R 16/03

(52) U.S. Cl. CPC B60R 16/03

(57) ABSTRACT

The present invention discloses a mechanism (100), wherein the mechanism comprises a sliding component (101) enabling a transition from a horizontal orientation to a vertical orientation of the HVJB/PDU, mitigating the risk of inadvertent foreign object ingress and related electrical hazards. Furthermore, the mechanism (100) comprises a self-locking component (102) integrated into the sliding component (101) to firmly secure the HVJB/PDU in either a vertical position or an inclined position, facilitating efficient servicing, commissioning, and decommissioning. The sliding component (101), operates seamlessly on a dual-rail system, thereby facilitating precise and controlled movement.

The following specification particularly describes the invention and the manner in which it is to be performed:

### DESCRIPTION OF THE INVENTION

### Technical Field of the Invention

The present invention relates to the field of vehicular electrical systems, and more specifically, it pertains to mechanisms for adjusting the orientation of High Voltage Junction Boxes (HVJBs) and Power Distribution Units (PDUs) within vehicle cabins. These mechanisms are designed to ensure the safe and efficient execution of key operations, encompassing the commissioning, maintenance, and decommissioning of HVJBs and PDUs within electric vehicles.

### BACKGROUND OF THE INVENTION

In the rapidly evolving landscape of electric and hybrid vehicles, the efficient management of high-voltage electrical systems is paramount. High Voltage Junction Boxes (HVJBs) and Power Distribution Units (PDUs) play a pivotal role in distributing and controlling electrical power to various components within these vehicles, including the battery pack, electric motors, and auxiliary systems. Ensuring the proper orientation and secure positioning of HVJBs and PDUs is critical for their optimal function and safety.

Traditionally, HVJBs and PDUs have been mounted in fixed orientations within vehicle cabins, which may not always be conducive to efficient servicing, commissioning, or decommissioning. This static positioning can pose challenges in terms of accessibility, safety, and operational ease when these components require maintenance, repair, or replacement. Furthermore, inadvertent intrusion by foreign objects and the associated electrical hazards present additional concerns when HVJBs and PDUs are situated in fixed positions. Such hazards can lead to operational disruptions, safety risks, and increased maintenance demands, all of which are undesirable in the context of electric and hybrid vehicles.

To address these pressing challenges and to enhance the safety and operational efficiency of HVJBs and PDUs, there is a compelling need for innovative mechanisms capable of facilitating the adjustment of these components' orientations within the vehicle cabin.

The Patent number U.S. Pat. No. 6,848,916B2 titled “Electrical junction box” relates to an electrical junction box comprises a junction box body and a cover which houses and holds the junction box body. A guide rail groove is provided on any one of an inner surface of the cover and an outer surface of the junction box body, and a guide rail guided by the guide rail groove is provided on the other thereof. Further, the junction box body is held in the cover at a slant with respect to the guide rail and the guide rail groove.

The Patent number KR200479836Y1 titled “Vehicular junction box unit” relates to a housing; A junction plate accommodating in the housing and for mounting a vehicle electronic device; and a plurality of junction plates, one end of which is mounted on the housing and the other end is mounted on the junction plate to draw the junction plate to the housing, The present invention provides a vehicle junction box unit having a drawable guide for guiding the vehicle.

The Patent number US20220126684A1 titled “Charging Connection Device for a Vehicle” relates to a charging connection device for a vehicle includes a junction box disposed in a recess, a junction box cover flap, and a cover flap. The junction box cover flap and the cover flap are each pivotable into an open position and a closed position. The junction box cover flap covers the junction box in the closed position and the recess is coverable by the cover flap. When the cover flap is displaced from the open position into the closed position the cover flap entrains the junction box cover flap. The junction box cover flap has a first element of a junction box connecting device and the junction box or a component that defines the recess has a second element of the junction box connecting device. In the closed position of the junction box cover flap, the junction box cover flap is held magnetically releasably by the junction box connecting device.

The Patent number CN106314314A titled “Electric and control integration system of electric truck chassis and corresponding control method” relates to an electric and control integration system and method of an electric truck chassis. The system comprises vehicle-mounted low-voltage power utilization equipment, vehicle-mounted high-voltage power utilization equipment, a high-voltage/low-voltage power supply wire harness, a communication control wire harness, a pipeline system, a lower-voltage power distribution box, a power supply distribution box and a vehicle controller; the system is provided with an assembling bracket assembly arranged below a cab; the assembling bracket assembly is used for packaging all electric appliance parts and an auxiliary system; the lower-voltage power distribution box is connected with the vehicle-mounted low-voltage power utilization equipment through the low-voltage power supply wire harness; the power supply distribution box is connected with the vehicle-mounted high-voltage power utilization equipment through the high-voltage power supply wire harness; two ends of the communication control wire harness are connected with parts needing to be subjected to communication control, and the communication control comprises connection between the vehicle controller and the vehicle-mounted low-voltage power utilization equipment and between the vehicle controller and the vehicle-mounted high-voltage power utilization equipment respectively. When a car adopts the system, the space of the chassis can be saved, and the parts are convenient to modify, repair and maintain; an assembling process of a complete vehicle manufacturer is simplified in a production process; the production is convenient, and the technology and safety risks are reduced.

The Patent number U.S. Pat. No. 6,428,326B2 titled “Assembly of a vehicle body and an electrical connection box installed thereon” relates to an electrical connection box body installed on a vehicle body, for a temporary pivotable mounting of the box body on the vehicle body, one of the box body and the vehicle body has a shaft and the other has a bracket to receive the shaft at a predetermined location, so as to allow pivoting of the box body about the shaft axis. Locating guide surfaces position the box body relative to the vehicle body during mounting, prior to receipt of the shaft at said predetermined location on the bracket. This makes the operation of installing the box easier and more precise and avoids looseness of the box body during assembly operations carried out on the box.

Hence, there exists a need for an innovative mechanism meticulously engineered to facilitate the flexible adjustment of HVJB and PDU orientations within the confines of vehicle cabins.

### SUMMARY OF THE INVENTION

The present invention overcomes the drawbacks of the prior art by disclosing a novel mechanism designed to facilitate the adjustment of High Voltage Junction Boxes (HVJBs) and Power Distribution Units (PDUs) within vehicle cabins. The mechanism offers a comprehensive solution to address safety and operational concerns during commissioning, servicing, and decommissioning of HVJBs and PDUs. The core components of this mechanism comprise a sliding component enabling a seamless transition from horizontal to vertical orientation for HVJBs/PDUs, effectively mitigating the risks associated with inadvertent foreign object ingress and consequential electrical hazards. An integrated self-locking component firmly secures the HVJB/PDU in either a vertical or inclined position, thereby facilitating efficient servicing, commissioning, and decommissioning procedures. The sliding mechanism operates on a dual-rail system, incorporating an integrated rod mechanism for precise and controlled movement and positioning of HVJBs/PDUs.

The present invention ensures improved safety and operational ease during commissioning and decommissioning processes. Additionally, the mechanism's ergonomic design, conforming to established ergonomic standards, simplifies the operation involved in HVJB/PDU commissioning and decommissioning, thereby advancing the efficiency and safety of maintenance practices in the domain of electric and hybrid vehicles.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1A-1B illustrates an isometric view of a mechanism for adjusting the orientation of a High Voltage Junction Box (HVJB)/Power Distribution Unit (PDU) within a vehicle cabin, according to an embodiment of the present invention.

FIG. 2A illustrates a horizontal position of the High Voltage Junction Box (HVJB)/Power Distribution Unit (PDU) within a vehicle cabin, according to an embodiment of the present invention.

FIGS. 2B, 2C and 2D illustrates a graphical representation of the multiple locking positions attainable by the mechanism, according to an embodiment of the present invention.

### DETAILED DESCRIPTION OF THE INVENTION

Reference will now be made in detail to the description of the present subject matter, one or more examples of which are shown in the figures. Each example is provided to explain the subject matter and not a limitation. Various changes and modifications obvious to one skilled in the art to which the invention pertains are deemed to be within the spirit, scope, and contemplation of the invention.

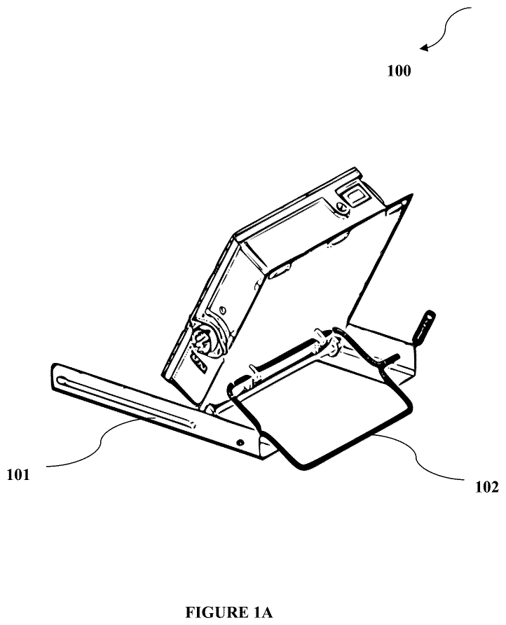

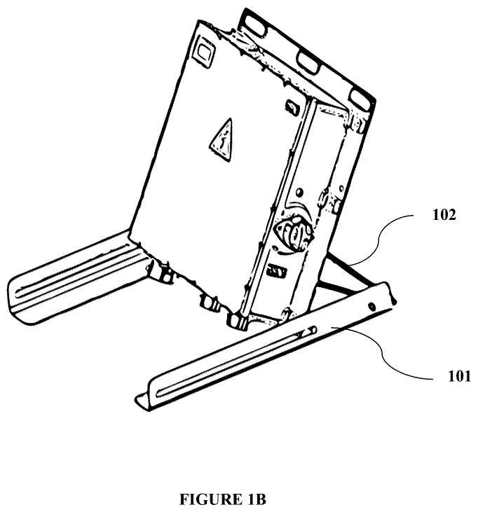

FIG. 1 illustrates an isometric view of a mechanism for adjusting the orientation of a High Voltage Junction Box (HVJB)/Power Distribution Unit (PDU) within a vehicle cabin, according to an embodiment of the present invention. The mechanism (100) comprises a sliding component (101) enabling a transition from a horizontal orientation to a vertical orientation of the HVJB/PDU, mitigating the risk of inadvertent foreign object ingress and related electrical hazards. Furthermore, the mechanism (100) comprises a self-locking component (102) integrated into the sliding component (101) to firmly secure the HVJB/PDU in either a vertical position or an inclined position, facilitating efficient servicing, commissioning, and decommissioning.

The sliding component (101), operates seamlessly on a dual-rail system, thereby facilitating precise and controlled movement. This dual-rail configuration ensures that the HVJB/PDU can be accurately repositioned to attain various orientations, satisfying specific operational requirements. An integral part of this inventive design is the incorporation of the self-locking component (102) that synergizes seamlessly with the sliding component (101). This self-locking feature securely holds the HVJB/PDU in the selected orientation, ensuring both stability and safety in the chosen position.

The capacity to achieve multiple positions is of significant advantage, particularly when the servicing of HVJB/PDU components is necessitated. This innovative design empowers maintenance personnel to access and work on these critical electrical components with a remarkable degree of ease and precision, addressing an essential need within the realm of electric and hybrid vehicles. This configuration enhances servicing, commissioning, and decommissioning processes, ultimately advancing the efficiency and safety of maintenance practices in the domain of electric and hybrid vehicles.

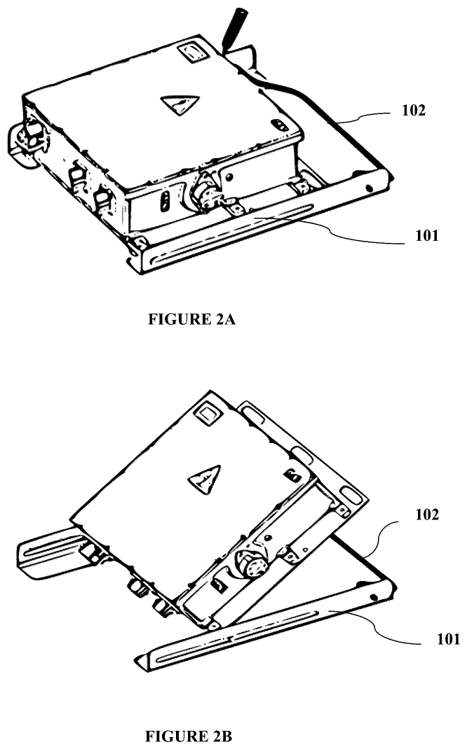

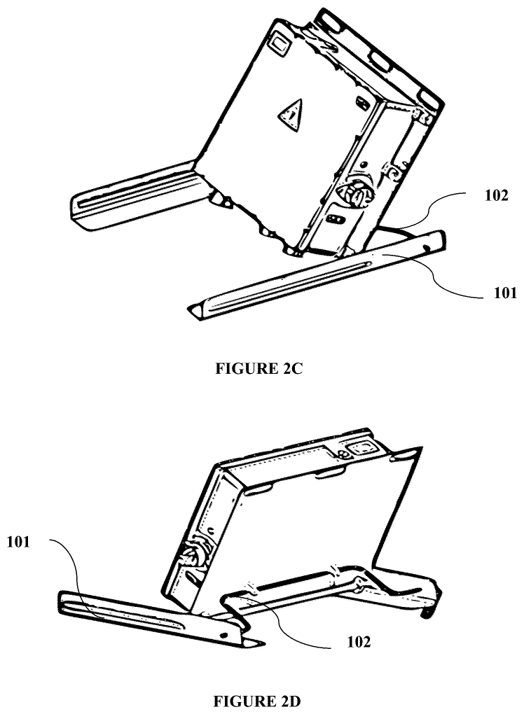

In an embodiment, the horizontal position as shown in FIG. 2A is typically employed during routine operations and when the HVJB/PDU is not undergoing maintenance or adjustments. On the contrary, vertical orientation is often preferred during commissioning, decommissioning, or servicing activities. It ensures improved accessibility and ease of interaction with the HVJB/PDU components. Further, inclined orientation are useful when specific operational requirements or spatial constraints necessitate variations in the orientation of the HVJB/PDU. The mechanism (100) allows for precise locking in inclined positions. Each locking position is meticulously designed to provide stability and security, guaranteeing that the chosen orientation remains intact during vehicle operation. This is of paramount importance as it prevents unintended shifts or movements that could compromise safety, electrical connections, or the overall functionality of the HVJB/PDU.

FIGS. 2B, 2C and 2D illustrates a graphical representation of the multiple locking positions attainable by the mechanism, according to an embodiment of the present invention. This visual representation emphasizes the mechanism's (100) adaptability in securely anchoring different orientations, a crucial attribute that substantially enhances its practical utility and broad applicability. These locking positions are essential for ensuring the stable and safe orientation of the High Voltage Junction Box (HVJB) or Power Distribution Unit (PDU) within the vehicle cabin. Each depicted locking position signifies a unique orientation that the mechanism can effectively maintain. This adaptability is achieved through the integration of the self-locking component (102), a pivotal feature of the mechanism. When the HVJB/PDU is positioned in one of these locking positions, the self-locking mechanism engages, securely holding the component in place.

These various locking positions are strategically designed to cater to diverse operational requirements. For instance, certain servicing tasks may necessitate a specific orientation for optimal accessibility and safety. The mechanism's (100) ability to securely maintain these orientations empowers maintenance personnel to work efficiently. Furthermore, the mechanism's (100) capacity to offer multiple locking positions aligns with the dynamic nature of electric and hybrid vehicle systems. These systems may require different HVJB/PDU orientations to accommodate various electrical connections, operational modes, or maintenance procedures. The mechanism's adaptability simplifies these tasks and enhances the overall efficiency of managing high-voltage electrical components within the vehicle cabin.

The locking positions illustrated in FIG. 2 cater to a wide range of scenarios, from optimizing space utilization within the vehicle's cabin to facilitating efficient access for maintenance and servicing tasks. The mechanism's (100) ability to securely maintain different orientations significantly streamlines these essential activities.

The disclosed mechanism (100) addresses the formidable challenge of accommodating a High Voltage Junction Box (HVJB) within low-floor vehicles while complying with regulations. By facilitating seamless orientation adjustments, the mechanism (100) enables optimal HVJB positioning, even within confined vertical spaces. This not only ensures regulatory compliance but also enhances vehicle design flexibility, granting manufacturers greater latitude in navigating safety and space limitations.

Further, the mechanism (100) effectively resolves ergonomic concerns, a paramount aspect in the efficient operation and maintenance of electrical components within vehicles. Through its ability to facilitate precise orientation adjustments, it enhances user comfort, safety, and operational efficiency during commissioning, maintenance, and decommissioning procedures. This adherence to established ergonomic standards streamlines operational aspects, creating an environment conducive to optimal performance and user satisfaction.

Furthermore, the mechanism (100) contributes significantly to safety by mitigating electric shock hazards. The secure and stable positioning of the HVJB is crucial in minimizing the risk of electrical accidents. Through the provision of multiple locking positions, the mechanism ensures the HVJB remains securely in place, reducing the likelihood of unintended movements or dislodgment. This enhanced stability is a proactive measure to prevent electric shock incidents, aligning with rigorous safety standards and regulations governing electric vehicles. It thereby enhances the overall safety profile of these vehicles, safeguarding both maintenance personnel and vehicle occupants.

### REFERENCE NUMBERS

| Components | Reference Numbers |
|---|---|
| Mechanism | 100 |
| Sliding component | 101 |
| Self-locking component | 102 |

We claim:

1. A mechanism for adjusting the orientation of a High Voltage Junction Box (HVJB)/Power Distribution Unit (PDU) within a vehicle cabin, the mechanism (100) comprising:
a. a sliding component (101) enabling a transition from a horizontal orientation to a vertical orientation of the HVJB/PDU, mitigating the risk of inadvertent foreign object ingress and related electrical hazards; and
b. a self-locking component (102) integrated into the sliding component (101) to firmly secure the HVJB/PDU in either a vertical position or an inclined position, facilitating efficient servicing, commissioning, and decommissioning.

2. The mechanism (100) as claimed in claim 1, wherein the sliding mechanism operates on a dual-rail system, with an integrated rod mechanism to facilitate controlled movement and positioning of the HVJB/PDU.

3. The mechanism (100) as claimed in claim 1, wherein the transition in the vertical orientation of the HVJB/PDU ensures improved safety and ease of operation during commissioning and decommissioning.

4. The mechanism (100) as claimed in claim 1, wherein the High Voltage Junction Box (HVJB)/Power Distribution Unit (PDU) is positioned on the floor of the vehicle's cabin.

5. The mechanism (100) as claimed in claim 1, wherein the mechanism (100) further comprises an ergonomic design that conforms to ergonomic standards, thereby simplifying the operation involved in HVJB/PDU commissioning and decommissioning.
